(19) United States
(12) Patent Application Publication
(10) Pub. No.: US 2015/0225807 A1
(43) Pub. Date: Aug. 13, 2015

(54) DEVICE FOR HEAT TRANSFER DURING THE PRODUCTION OF ELONGATED STRAND SHAPED MATERIAL

(71) Applicant: Maschinenfabrik NIEHOFF GmbH & Co. KG, Schwabach (DE)

(72) Inventor: Hubert Reinisch, Freiberg am Neckar (DE)

(21) Appl. No.: 14/691,049

(22) Filed: Apr. 20, 2015

Related U.S. Application Data
(63) Continuation of application No. PCT/EP2013/002023, filed on Jul. 9, 2013.

(30) Foreign Application Priority Data
Oct. 19, 2012 (DE) 10-2012-020622.4

(51) Int. Cl. C21D 9/56; C22F 1/04; C22F 1/08; F27B 17/00; C21D 9/52

(52) U.S. Cl. CPC C21D 9/56; F27B 17/0016; C21D 9/525; C22F 1/08; C22F 1/04; F27B 2017/0091; F27D 15/00

(57) ABSTRACT

An apparatus for a processing of a strand shaped material including a heat transfer device is disclosed. In one aspect, the apparatus is adapted to process an elongated strand shaped material. The heat transfer device includes a heat transfer medium and is configured to process a first section of the strand shaped material having a first initial temperature. The heat transfer device is configured to reduce the initial output temperature by conducting a heat flow. The heat transfer device is further configured to process a second section of the strand shaped material having a second initial temperature that is lower than the first initial temperature. The heat transfer medium is configured to conduct the energy flow to the second wire section so as to increase the second initial temperature.

### CROSS-REFERENCE TO RELATED APPLICATIONS

This application is a continuation application, and claims the benefit under 35 U.S.C. §§120 and 365 of PCT Application No. PCT/EP2013/002023, filed on Jul. 9, 2013, which is hereby incorporated by reference. PCT/EP2013/002023 also claimed priority from German Patent Application No. 10 2012 020 622.4 filed on Oct. 19, 2012, which is hereby incorporated by reference.

### BACKGROUND

1. Field

The described technology generally relates to a device for transferring heat during the production of an elongated strand shaped material and a method for operating such a device.

2. Description of the Related Technology

Both in private and industrial sectors, the energy consumption becomes more and more important, especially with the rising of the energy costs. As a result of this development, a general goal of the technical innovations is to reduce the energy consumption and to increase the efficiency, especially for the energy intensive processes. In particular, the production of semi-finished products with high degrees of deformation is often such an energy intensive process, including the producing and the processing of the elongated strand shaped material. During the production of such an elongated strand shaped material, it is usually necessary to provide for, in addition to the high mechanical performance for achieving the desired plastic deformation, also a high thermal performance for setting the desired metal lattice structures by a stress relief annealing or even a recrystallization annealing.

### SUMMARY OF CERTAIN INVENTIVE ASPECTS

One inventive aspect relates to the production of an elongated strand shaped material in a so-called in-line process. In some embodiments, the elongated strand shaped material is at first mechanically deformed, then it is heated and cooled, and finally wound up. The degrees of the deformation during the plastic deformation of the semi-finished product can be so large that the deformation process is accompanied by thermal processing steps. This can allow to set the desired microstructure. Such thermal processing steps are understood to be in particular annealing processes, which have a high energy consumption. For the in-line annealing, the strand shaped material is heated by a conductive heating or by an inductive heating in a so-called wire annealer until the desired microstructure of the material has been set and the brittleness of the strand shaped material has been reduced.

A further processing of the elongated strand shaped material, for example, the winding on a coil at the end of the production or the scheduled processing of the strand shaped material would be difficult or not possible at all for the nonannealed state. The annealing process is completed in that after a sufficient time the heat energy is removed from the elongated strand shaped material by a suitable cooling device. This cooling serves on the one hand for a targeted process control and on the other hand it simplifies the handling of the elongated strand shaped material immediately after the production. The heat energy removed from the strand shaped material is often discharged to the environment without any further use. It is also possible that during the cooling of the elongated strand shaped material, the environment is contaminated with water vapor, or the like, this may degrade the working conditions for the operating personnel at such a system. It is known occasionally to supply the heat energy, which has been removed from the elongated strand shaped material, to the energy supply net, wherein such a use of the heat energy is only limitedly possible. On the one hand, the heat energy incurs regardless of the actual needs, on the other hand, the incurred heat energy has to be often converted into other forms of energy or to be transmitted over long distances, wherein this is accompanied by losses and reduces the overall efficiency.

Another aspect is to increase the overall efficiency of a device for producing an elongated strand shaped material, and to thereby reduce its energy consumption.

In the sense of the present invention, a heat transfer device includes a device for transferring heat energy. The heat energy can be transferred within an apparatus for the processing of the elongated strand shaped material by means of a heat transfer device. The form of the energy may not change during the transfer. The heat energy may not be converted into an electrical form of energy, into a mechanical form of energy or into another form of energy. The heat energy can be conducted in a targeted heat flow. The direction of the heat flow may be set on its own by a temperature gradient.

An elongated strand shaped material can include a geometric body having a cross-sectional area and a longitudinal extension, which is, for example, arranged substantially orthogonal to the cross-sectional area. The spatial dimensions of the cross-sectional area can be very small compared to the longitudinal extension. The spatial dimensions of the cross-sectional area can be in the range of single millimeters or single tenths of a millimeter, respectively. The longitudinal extension can be an extension of meters up to a virtually endless length. The strand shaped material can have a component a “good” electrical conductor, for example, a metallic material, such as copper, aluminum or steel. The strand shaped material can include one of the aforementioned components, or the strand shaped material can include an alloy, in which at least an essential part is one of the aforementioned components, respectively. The cross-sectional area can have a specific geometrical shape, such as a polygonal shape, a rounded shape, an oval shape, or a circular shape. The elongated strand shaped material can be provided as a copper wire, a steel wire or an aluminum wire having a circular cross-section.

In some embodiments, a first section of the strand shaped material includes a continuous region of the strand shaped material. A second section can be a further region of the same strand shaped material or of other strand shaped material. The first section of the strand shaped material and the second section of the strand shaped material can be regions on the same body or they can be regions on different bodies.

In some embodiments, a heat transfer medium includes a medium for the transfer of an amount of heat. The amount of heat, the thermal energy, the energy flow and the heat flow can be interchangeable. The heat transfer medium can be adapted to transport the heat. The heat transfer medium can have a component with “high” thermal conductivity λ. The high thermal conductivity can be larger than about 0.025 W/(mK). The component is selected so that it has a thermal conductivity in a range of about 1000>λ>about 0.025, such as about 500>λ>about 0.5, and about 400>λ>about 0.59. The heat transfer medium can include at least one of the following components: water, ethanol, steel, aluminum, copper, brass, oil or the like. The heat transfer medium can also include a mixture of substances in which one of the before mentioned components is an essential part.

In some embodiments, a first initial temperature is a temperature of the first section of the strand shaped material before from the section of the strand shaped material a heat flow is discharged as scheduled by the heat transfer medium, especially just immediately before the heat flow is discharged.

In some embodiments, a second initial temperature is a temperature of the second section of the strand shaped material before to the section of the strand shaped material a heat flow is supplied as scheduled by the heat transfer medium, for example, just immediately before the heat flow is supplied.

The first initial temperature can be reduced by the discharge of the heat flow and the second initial temperature is increased by the supplying of the heat flow. The heat flow can be transferred as completely as possible from the first section of the strand shaped material to the second section of the strand shaped material by means of the heat transfer medium.

In some embodiments, in conducting the heat flow or of the energy flow, the heat energy can be transferred from a first location to a second location. For example, the amount of heat of the first section is transferred to the second section of the strand shaped material. The heat flow can be transferred by convection and it is accompanied by a particle flow, for example, a liquid flow or gas flow. The heat flow can be transferred by a thermal radiation or a thermal conduction, for example, without a particle flow. The heat flow can be transferred by means of the heat transfer medium. The heat flow can be transferred through a combination of the aforementioned effects, or only by one of the aforementioned effects. The heat flow can be conducted along a temperature gradient, wherein such a temperature gradient is formed by the contacting of the heat transfer medium with the first section of the strand shaped material and with the second section of the strand shaped material.

The heat transfer medium can be a medium with an indefinite geometric shape. The medium can have a liquid form or a gaseous form. The medium can change its physical state during the conduction of the heat flow (liquid form-gaseous form, gaseous form-liquid form). A liquid heat transfer medium or a gaseous heat transfer medium allows a particularly simple management of the heat transfer medium. Alternatively, it is also possible that the heat transfer medium is received in a defined space through which is guided both the first section of the strand shaped material and the second section of the strand shaped material.

The heat transfer medium can be in direct contact with at least one of the two sections of the strand shaped material. At least one of these sections of the strand shaped material can be guided through a space in which the heat transfer medium is accommodated. The second one of these sections of the strand shaped material can be guided through the space, and thereby it is also in direct contact with the heat transfer medium. By the direct contact of these sections of the strand shaped material, a particularly good discharge of the heat flow of the heat transfer medium or a particularly good receiving of the heat flow from the heat transfer medium can be made possible, for example, by the large contacting area. Such a configuration can allow a particularly simple structure of the heat transfer device. By transferring the heat from the first section of the strand shaped material to the second section of the strand shaped material, it can be achieved that for the heating of the second section of the strand shaped material only the energy for the annealing has to be supplied, which has not been transferred from the first section of the strand shaped material, thus the efficiency of the apparatus for the processing of the strand shaped material is increased.

The heat transfer medium may not be in direct contact with one of these sections of the strand shaped material. The heat transfer medium can be guided in a guiding device. The guiding device can include pipes, tubes, ducts or the like. The first section of the strand shaped material can transfer the heat flow to the heat transfer medium by means of a thermal radiation or a thermal conduction and additionally or alternatively by means of convection. The heat transfer medium flows through the guiding device to the second section of the strand shaped material and transfers the heat flow by a radiation and additionally or alternatively by a convection and a thermal conduction to the second section of the strand shaped material. An example includes heat pipes (so-called heat pipes). For such an embodiment, interactions between the materials of the sections of the strand shaped material and the heat transfer medium are not possible, because they do not come into direct contact with each other. Thus, on the one hand, it can be prevented that the respective section of the strand shaped material is contaminated by the heat transfer medium. And on the other hand, it can be prevented that impurities are introduced into the heat transfer medium. By such a configuration, the efficiency of the apparatus for the processing of the strand shaped material can increase, since impurities can be reduced while the heat energy can be transferred from the first section of the strand shaped material to the second section of the strand shaped material.

The heat transfer medium can be a geometric body with an arbitrary contour, e.g., a body in a solid state of aggregation. At least one of these two sections of the strand shaped material, for example, both sections can be in direct contact with the heat transfer medium. By a heat transfer medium having a solid state of aggregation, it is possible that no sealings are necessary. This allows a very simple structure of the heat transfer device and at the same time it increases the efficiency of apparatus for the processing of the strand shaped material. By directly contacting the sections of the strand shaped material, in the heat transfer medium, a particularly good heat transfer can be achieved from these sections of the strand shaped material. Concerning the direct contacting, it may not conflict that this heat transfer medium has a coating on its surface, for example, in the area of contact with this section of the strand shaped material. Such a coating can serve to reduce or to prevent a particle transfer from the heat transfer medium to the section of the strand shaped material. Further, such a coating can be adapted to reduce welding of the section of the strand shaped material with the heat transfer medium. Such a coating can be adapted to improve the heat transfer further, for example, by an enlargement of the contact surface between the heat transfer medium and the section of the strand shaped material. Such a coating can be applied only temporary and will be renewed continuously or, in particular discontinuously.

The heat energy can be transferred from the first wire section to the second wire section by several heat transfer media, for example, by several different heat transfer media. One of these heat transfer media in the form of a geometric body, for example, in the form of roller-like body, can be surrounded by one of the heat transfer media in a liquid form or in a gaseous form. The liquid heat transfer medium or the gaseous heat transfer medium can serve also for the protection of the first section of the strand shaped material or of the second section of the strand shaped material. The liquid heat transfer medium can be oil, water, or a mixture of oil and water, for example, an oil-water emulsion. Such a heat transfer medium can have a boiling point in a range from about 100° C. to about 400° C., for example, in a range from about 150° C. to about 350° C. The boiling point can be at about 200° C. or about 350° C. In the case of a heat transfer through a plurality of cascaded heat transfer devices, the same gaseous heat transfer medium or the same liquid heat transfer medium is used in all the heat transfer devices. By such a uniform heat transfer medium, during the serial passage of these sections of the strand shaped material, no contamination occurs due to different heat transfer media, which adhere to the section of the strand shaped material. Further, the different heat transfer media can be used in the different heat transfer devices. For example, by using the different gaseous heat transfer media or the different liquid heat transfer media, it is possible to adjust the temperature range to the respective cascade and therefore to improve the heat transfer. The gaseous heat transfer medium, such as air, argon, nitrogen or other gases, including those which are known from fusion welding processes and the like, can be used. The gaseous heat transfer medium used can be a mixture, in which one of the above mentioned gases is at least one component. One of these heat transfer media, which is formed as a geometric body, can be operated in a substantially evacuated space. For example, the heat transfer media can be operated by a gaseous heat transfer medium in the above described form, or by an evacuated environment, contaminations of the sections of the strand shaped material are reduced.

The heat transfer medium can be designed substantially as a roller-like body. The roller-like body can have a circular cross-sectional area. The roller-like body can have a longitudinal extension, which is substantially perpendicular to the cross-sectional area. The first section of the strand shaped material and/or the second section of the strand shaped material can contact the roller-like body at least partially along a lateral area, wherein the lateral area surrounds the cross-sectional area and it is extending in the direction of the longitudinal extension. Further, the roller-like body can have an axis of rotation, wherein the axis of rotation has essentially an equidistant distance to the lateral area. By such a construction, a substantially cylindrical lateral area can be achieved. The roller-like body can rotate around the axis of rotation during the processing of the elongated strand shaped material. It can be a symmetry axis of the cylindrical lateral area. The speed, by which the roller-like body rotates, can be selected such that the speed of the lateral area corresponds to the speed of the strand shaped material, which is contacting it. Such a configuration of the heat transfer medium allows for a substantially frictionless contact between the strand shaped material and the heat transfer medium, and thus it allows for a particularly good heat transfer from the first section of the strand shaped material to the heat transfer medium or it allows for a particularly good heat transfer from the heat transfer medium to the second section of the strand shaped material, whereby an increasing efficiency is achieved for the apparatus for the processing of the strand shaped material.

The lateral area can include at least one groove-like indentation. The indentation can be provided for the purpose of accommodating the first section of the strand shaped material or the second section of the strand shaped material during the processing of the strand shaped material. The groove-like indentation can be designed circumferentially around the lateral area, for example, it is completely circumferential. The cross-section of the indentation can be oriented to the shape of the elongated strand shaped material. An orientation of the shape of the indentation to the shape of the strand shaped material can be configured such that in the case of a circular cross-section of the strand shaped material, the indentation in the lateral surface extends partially at least circular so that a huge contacting area between the strand shaped material and the heat transfer medium is made possible, and thus the heat transfer has been improved. The groove-like indentation can be constructed as a groove encircling the roller-like heat transfer medium and having a preferably polygonal circular cross-section, for example, a rectangular circular cross-section, a triangular circular cross-section, an oval circular cross-section, or a circular cross-section. The indentation may not be oriented to the cross-section of the strand shaped material. Likewise, the indentations, which are designed to be elastic in sections, so that it has been achieved an adapting of or an independent generating of a large contacting area, respectively for the strand shaped material. By a groove-like indentation in the heat transfer medium, the contacting area can increase between one of these sections of the strand shaped material and the heat transfer medium, and thus allows a more efficient heat transfer. On the other hand, the guiding of the strand shaped material is improved.

The heat transfer medium can include at least a first one and a second one of these indentations. The heat transfer medium can include a first group of these indentations and a second group of these indentations, wherein a group of the indentations has a plurality of these indentations. The first group of indentations or the first indentation can be adapted to contact the first section of the strand shaped material and the second indentation or the second group of indentations can be adapted to contact the second section of the strand shaped material. For example, due to the first initial temperature, which is higher than the second initial temperature, in the heat transfer medium, it is resulting in a heat flow from the first indentation or from the first group of indentations to the second indentation or to the second group of indentations. Due to the construction with different indentations for the first section of the strand shaped material and for the second section of the strand shaped material on the same heat transfer medium, which can have a good thermal conductivity, an efficient heat transfer is achieved from the first section of the strand shaped material to the second section of the strand shaped material.

In some embodiments, the first section of the strand shaped material wraps around the heat transfer medium with a first wire wrapping angle α and the second section of the strand shaped material wraps around the heat transfer medium with a second wire wrapping angle β. Such a wire wrapping angle can be the angle, which indicates the distance along which the first section of the strand shaped material or the second section of the strand shaped material contacts the heat transfer medium. Such a wire wrapping angle can be the sum of several parts, for example, in the case that the section of the strand shaped material contacts the heat transfer medium several times. For example, such multiple contacts occur when the section of the strand shaped material contacts alternately the deflection device and the heat transfer medium. The wire wrapping angle can be greater than a full circle (2π or 360°). The first wire wrapping angle and the second wire wrapping angle can be different. By different wire wrapping angles, for example, for the case of the same diameter of the heat transfer medium in the area of contacting by the first section of the strand shaped material and in the area of contacting by the second section of the strand shaped material, it can result in different lengths of the contacting area between the first section of the strand shaped material and the heat transfer medium, and the second section of the strand shaped material and the heat transfer medium. The diameters of the heat transfer medium can be (slightly) different to compensate for the differences in thermal expansion in the strand shaped material in the longitudinal direction of the strand shaped material. The amount of heat, which is transferred between these sections of the strand shaped material and the heat transfer medium, can therefore be affected by the simple geometric relation (the wire wrapping angle). Thus, a particularly simple influence of the transferred amount of heat can be obtained, and thus a particularly efficient design of the device can be obtained.

In some embodiments, the second wire wrapping angle β is larger than the first wire wrapping angle α. The amount of heat, which is transferred from of one of these sections of the strand shaped material, can depend on the temperature difference between the heat transfer medium and the section of the strand shaped material. In order to ensure the most efficient use of the amount of heat QI of the first section of the strand shaped material, the amount of heat QII, which has been transferred to the second section of the strand shaped material, can substantially correspond to the amount of heat QI. For example, for industrially realistic conditions, some losses have to be expected, so that in general, the amount of heat QI can only essentially correspond to the amount of heat QII. In general, the temperature difference between the first section of the strand shaped material and the heat transfer medium will be larger than the temperature difference between the second section of the strand shaped material and the heat transfer medium. In some embodiments, it has been not excluded that the heat transfer medium in general has not of uniform temperature, but it has locally different temperatures. A larger temperature difference, for otherwise identical conditions, would usually lead to a better heat transfer. The second wire wrapping angle can be chosen to be so large that essentially the same amount of heat is transferred from the heat transfer medium to the second section of the strand shaped material as it is transferred from the first section of the strand shaped material to the heat transfer medium. For example, by a second wire wrapping angle β, which is not equal to the first wire wrapping angle α, a very efficient heat transfer between the first section of the strand shaped material and the section of the strand shaped material can be achieved by means of the heat transfer medium.

In some embodiments, the first wire wrapping angle and the second wire wrapping angle satisfy a relation in the form of: α*K=β*L. The wire wrapping angles can be regarded as angles in radians. These factors K and L can include factors being influenced by different parameters. These factors can be influenced by the parameters as the first initial temperature, the second initial temperature, the temperature of the heat transfer medium in the region of contacting the first section of the strand shaped material and the second section of the strand shaped material. These factors can also be influenced by the parameters by which the heat transfer of these sections of the strand shaped material to the heat transfer medium can be described. Such heat transfer parameters can be empirically determined values, for example, such parameters can be tabular values. These factors can include a threshold temperature, especially for the heat transfer medium. Such a threshold temperature can be a temperature, at which the heat transfer medium is permanently operable, or a temperature, which adjusts itself as a steady-state temperature for the heat transfer medium. These factors can be geometrical quantities such as a length, a width and a diameter of the heat transfer medium and of these sections of the strand shaped material, and it can also be the geometrical parameters which describe the indentation. By the description of the wire wrapping angle according to the described type and a very efficient transfer of the amount of heat can be achieved from the first second section of the strand shaped material to the second section of the strand shaped material.

The axis of rotation of the heat transfer medium can be aligned substantially orthogonal to a moving direction of the second section of the strand shaped material or of the second section of the strand shaped materials. The heat transfer device can include a deflection device. The deflection device can be designed as a roller device. For example, the deflection device has a rotational axis. The rotational axis of the deflecting means can be oriented askew in regard to the rotation axis of the heat transfer medium. One of these sections of the strand shaped material, the first section of the strand shaped material or second section of the strand shaped material, can contact alternately the heat transfer device and the deflection device. Multiple deflection devices can be assigned to one of these heat transfer media. In some embodiments, in the assignment can include a scenario where one of these sections of the strand shaped material contacts the heat transfer medium during its moving as scheduled, so then it contacts a first deflection device and then again it contacts the heat transfer medium and then it contacts a second deflection device. In such a case, the first deflection device and the second deflection device are assigned to the heat transfer medium. One of these heat transfer media can also be assigned to more than two deflection devices. By one of the described configurations of the heat transfer device with one or more deflection devices, a particularly reliable and accurate guiding of the sections of the strand shaped material can be achieved, and thereby it is made possible a particularly good and efficient heat transfer from the first section of the strand shaped material to the second section of the strand shaped material.

In some embodiments, the axis of rotation of the heat transfer medium is arranged askew to the moving direction of the first section of the strand shaped material or of the second section of the strand shaped material. The rotation axis can be inclined relative to the plane, which is normal to the moving direction of the elongated the strand shaped material, at an angle of between zero and about 25 degrees. By the inclination of the rotation axis, especially without a deflection device, the elongated strand shaped material can contact the heat transfer medium for a very large wire wrapping angle. In this connection, a large wire wrapping angle can be a wire wrapping angle of more than about π/4 or about 90 degrees, respectively. For example, by such a heat transfer device having a large wire wrapping angle and having not a deflection device, a particularly efficient heat transfer can be obtained, and therefore an improved system for the processing of strand shaped material is provided.

Another aspect is an apparatus for the processing of a strand shaped material including several heat transfer devices, which are arranged one behind the other. These apparatuses for the processing of the strand shaped material can include a plurality of substantially identical heat transfer devices, and they can include a plurality of identical heat transfer devices. The apparatus can include a plurality of, but at least two, different heat transfer devices. The first section of the elongated strand shaped material can pass through the heat transfer devices serially, i.e., in a temporal succession. The second section of the strand shaped material, which can be a further section of the same elongated strand shaped material, can pass through these heat transfer means, for example, in a direction, which is opposite to the direction of the first section of the strand shaped material. The first section of the strand shaped material and the second section of the strand shaped material may not be part of the same strand shaped material, but parts of each different ones. In each of these heat transfer devices, a part of the heat energy can be transferred from the first section of the strand shaped material to the second section of the strand shaped material. For example, by the partial transfer, the use of the heat transfer devices is possible, which are specially tuned to a narrow operating range and which are therefore efficiently operating. By using several heat transfer devices, it can be achieved a thermodynamically highly efficient transfer of the heat energy from the first section of the strand shaped material to the second section of the strand shaped material, and therefore it can be provided a particularly efficient apparatus for the processing of a strand shaped material.

The temperature of the section of the strand shaped material can be influenced by an additional temperature control device. An additional temperature control device can include a temperature control device for controlling the temperature of these sections of the strand shaped material, for example, for a decreasing of the temperature or for an increasing of the temperature. Such an additional temperature control device can include a heating device, wherein such a heating device heats the section of the strand shaped material in a conductive manner or in an inductive manner. The additional temperature control device can include a device for cooling the section of the strand shaped material, for example, as a cooling device. As a cooling device can be any device, which removes as scheduled the heat energy from the section of the strand shaped material, for example, a heat exchanger device or the like. As pointed out, thermodynamically, not the complete heat energy of the first section of the strand shaped material can be transferred to the second section of the strand shaped material. By an additional temperature control device, for example, by a heating device, the difference heat energy can be supplied to the second section of the strand shaped material. The first section of the strand shaped material may not be cooled to a sufficiently low temperature by one of these heat transfer media; for example, by a cooling device, the section of the strand shaped material is then cooled to the required temperature. The heat transfer device can include one of these heating devices and one of these cooling devices. The group of the heat transfer devices can include one of these heating devices and one of these cooling devices. For example, by the additional temperature control device, a more accurate adjustment of the desired temperatures is possible in these sections of the strand shaped material, whereby it can be provided a particularly efficient apparatus for the processing of a strand shaped material.

Another aspect is a method for the operating of the apparatus for the processing of a strand shaped material, the method including discharging an energy flow, for example, a heat flow of the first section of the strand shaped material, conducting, at least a part of the energy flow onto the heat transfer medium, transferring, at least a part of the energy flow through the heat transfer medium to the second section of the strand shaped material, and supplying, at least a part of the energy flow to the second section of wire.

In discharging the energy flow, for example, from the first section of the strand shaped material, the heat energy can be removed from the section, for example, for adjusting the preferred microstructures by means of a specific annealing process, or for a better handling of the elongated strand shaped material.

The conducting of the energy flow can include a heat flow along a thermal gradient, for example, in the heat transfer medium. The thermal gradient can occur due to a temperature difference between the first section of the strand shaped material and the second section of the strand shaped material. The energy flow can be conducted from a contacting point of the heat transfer medium with the first section of the strand shaped material towards a contacting point with the second section of the strand shaped material.

The energy flow can be transferred; for example, it can be transferred completely except for unavoidable losses.

The heat energy can be transferred, as completely as possible, to the second section of the strand shaped material, by means of the heat transfer medium.

### BRIEF DESCRIPTION OF THE DRAWINGS

FIG. 1 is a device for the transferring of the heat energy according to one embodiment.

FIGS. 2a and 2b are multiple views of a heat transfer device according to one embodiment.

FIG. 3 is a heat transfer medium with a deflection device according to one embodiment.

FIG. 4 illustrates different indentations on a heat transfer medium according to one embodiment.

FIG. 5 illustrates a roller-type heat transfer medium according to one embodiment.

FIG. 6 illustrates a section through a heat transfer device according to one embodiment.

FIG. 7 illustrates a plurality of the cascaded heat transfer devices according to one embodiment.

FIG. 8 illustrates a cascaded arrangement of a plurality of the heat transfer devices according to one embodiment.

FIG. 9 illustrates the temperature of paths for a first second section of the strand shaped material and a second section of the strand shaped material during passage through a heat transfer device according to one embodiment.

### DETAILED DESCRIPTION OF CERTAIN INVENTIVE EMBODIMENTS

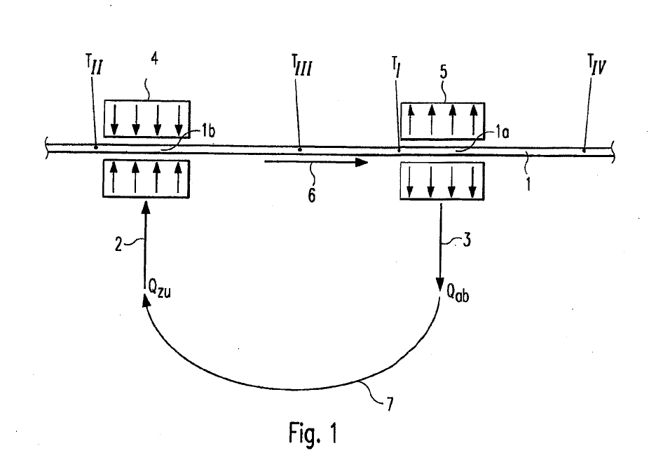

FIG. 1 shows a device for the transferring of an amount of heat from a first section 1a of the strand shaped material to a second section 1b of the strand shaped material according to one embodiment. In this case, the amount of heat (Q_{ab}) 3 is removed from the first section 1a of the strand shaped material and it is transferred to the second section 1b of the strand shaped material by means of a heat transfer medium 7. In a first section 5, the amount of heat Q_{ab} is removed from the first section 1a of the strand shaped material and it is conducted to the heat transfer medium 7. The heat transfer medium 7 conducts the amount of heat to a second section 4, and transfers the amount of heat Q_{zu} to the second section 1b of the strand shaped material. The first section 1a of the strand shaped material and the second section 1b of the strand shaped material are a part of a common extended strand shaped material 1. The strand shaped material 1 is conveyed along a moving direction 6 during the processing of the elongated strand shaped material in an apparatus for the processing of the strand shaped material. Before entering the section 4, the strand material has the initial temperature T_{II}. For influencing the microstructure of the material in the desired manner, the strand shaped material is annealed for a recrystallization at the temperature T_{III}. After the desired microstructure of the material has been obtained, the elongated strand shaped material 1 is cooled again in the section 5, and before entering the section the elongated strand shaped material has the temperature T_{I}. By this cooling, on the one hand, the annealing process is completed, and on the other hand, the elongated strand shaped material 1 can be better handled due the low temperature T_{IV}.

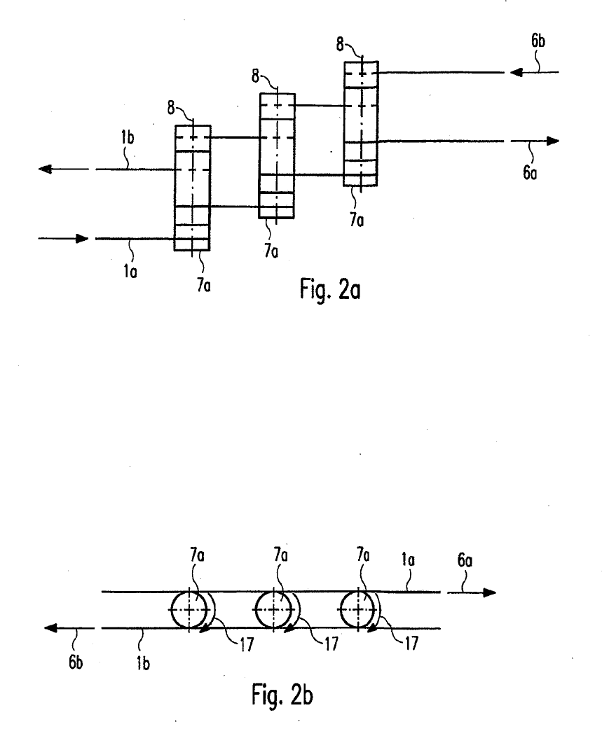

FIG. 2a shows a front view of a heat transfer device having several roller-type heat transfer media 7a according to one embodiment. Each of these heat transfer media 7a rotates around an axis of rotation 8. For this heat transfer device, a first section 1a of the strand shaped material moves in the moving direction 6a. A second section 1b of the strand shaped material moves in the moving direction 6b, which is the opposite direction to the moving direction 6a. By these several heat transfer media 7a, the amount of heat to be transferred is gradually transferred from the first section 1a of the strand shaped material to the second section 1b of the strand shaped material.

FIG. 2b shows a side view of the same heat transfer device as in the FIG. 2a. The first section 1a of the strand shaped material contacts the heat transfer media 7a at first at the top and then it circulates these heat transfer media 7a clockwise at first downwards in the direction 17 and leaves again the heat transfer medium at the top, wherein the first section 1a of the strand shaped material moves substantially in the direction 6a. The second section 1b of the strand shaped material moves substantially in the moving direction 6b and thus in the opposite direction to that of the first section 1a of the strand shaped material. The second section of the strand shaped material contacts the heat transfer medium 7a at first at the bottom and circulates it also clockwise in the direction 17. Further, the second section of the strand shaped material 1b leaves the heat transfer media 7a in turn below. From the FIGS. 2a and 2b, it can be seen that the respective sections of the strand shaped material wrap completely each heat transfer medium several times before they leave these again. By these multiple wrapping, the wire wrapping angle (not shown) becomes large, and thus a favorable heat transfer from the first section of the strand shaped material to the second section of the strand shaped material is made possible by means of the heat transfer medium.

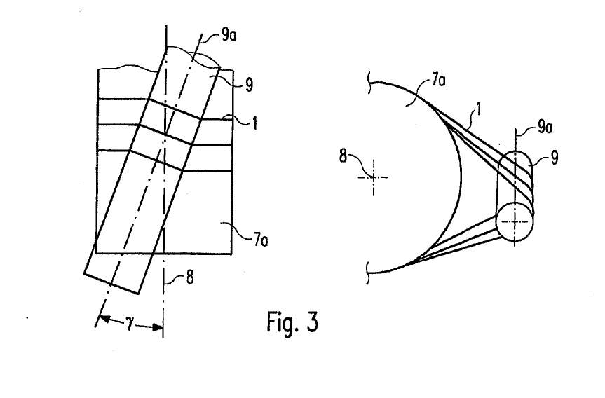

FIG. 3 shows a possible further embodiment of a heat transfer medium having a so-called deflection device 9. The heat transfer medium 7a is again configured as a roller, wherein the roller rotates around its axis of rotation 8. The strand shaped material 1 wraps the heat transfer medium 7a during the processing several times. In order to achieve a particularly good guidance of the strand shaped material 1 on the heat transfer medium 7a, it is lifted and deflected by the deflection device 9 of the heat transfer medium 7a. For this, the deflection device 9 rotates around its rotation axis 9a. For this deflection, the rotation axis 9a is pivoted by the angle γ in regard to the rotation axis 8. By this inclination of the two axes of rotation 9a and 8 against each other, a multiple wrapping of the heat transfer medium 7a by the elongated strand shape material 1 is possible and thereby a better heat transfer is obtained.

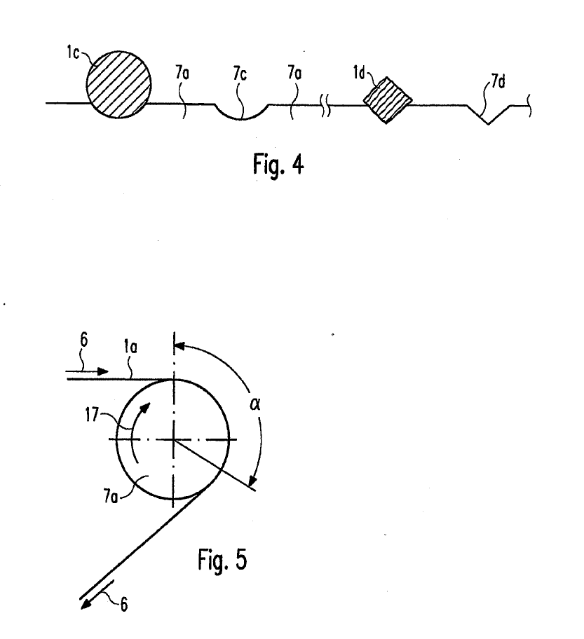

FIG. 4 shows different indentations 7c and 7d in a heat transfer medium 7a according to one embodiment. For this, the different indentations are provided for accommodating the strand shape material having different cross-sectional areas. The circular indentation 7c is provided for accommodating an elongated strand shape material having also a circular cross-sectional area 1c. The prism shaped indentation 7d is provided for accommodating an elongated strand shaped material having a polygonal cross-sectional profile id. By this assignment of the indentation to these cross-sectional areas, a larger contacting area between the heat transfer medium 7a and the elongated strand shaped material (1c, 1d) is obtained, and thus a better heat transfer is made possible.

FIG. 5 shows a roll-like heat transfer medium 7a, which is wrapped by a first section of the strand shaped material 1a according to one embodiment. In FIG. 5, the heat transfer medium 7a rotates in the direction 17, and transports thereby the first section of the strand shaped material 1a in the moving direction 6. The length of the contacting area between the first section 1a of the strand shaped material and the heat transfer medium 7a is defined by the wire wrapping angle α. The wire wrapping angle α is therefore a measure of the length of the contacting area between the section of the strand shaped material and the heat transfer medium.

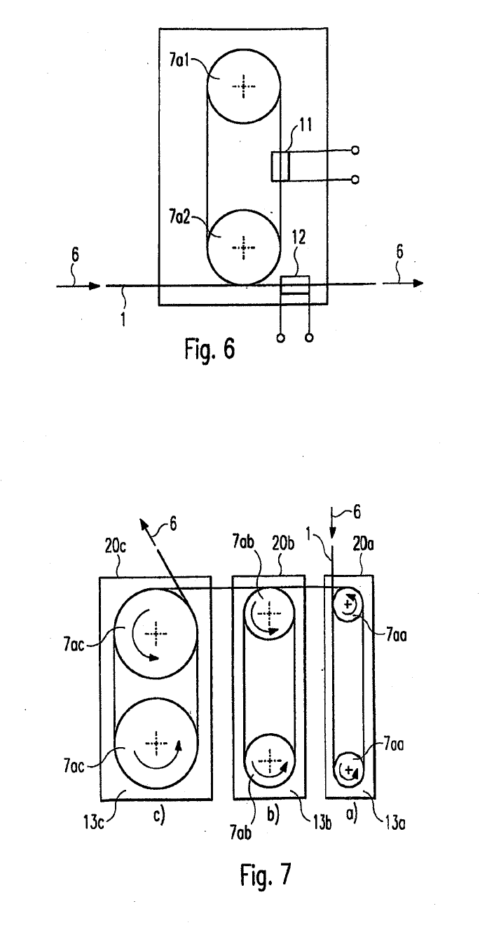

FIG. 6 shows a section through a heat transfer device according to one embodiment. In FIG. 6, the heat transfer device includes a first heat transfer medium 7a1 and a second heat transfer medium 7a2. Further, the heat transfer device has a first additional temperature control device 11 and a second additional temperature control device 12. The elongated strand shaped material 1 passes through the heat transfer device in the moving direction 6. For this, the FIG. 6 shows only a part of the heat transfer device. By means of the first additional temperature control device 11 and of the second additional temperature control device 12, the annealing process for the elongated strand shaped material 1 can be set very accurately. In this case, an amount of heat is transmitted to the elongated strand shaped material 1 by this first additional temperature control device in addition, for example by an auxiliary electric heating. By this second additional temperature control device 12, an additional amount of heat is removed from the elongated strand shaped material, for example by convection. By these additional temperature control devices, it is achieved a very precise process control of the annealing process for the elongated strand shaped material 1, and thus it is provided an improved apparatus for the processing of the strand shaped material.

FIG. 7 shows a plurality of heat transfer devices, which are connected in series according to one embodiment. For this, FIG. 7 shows only a part of these heat transfer devices. First, the elongated strand shaped material 1 moves in the moving direction 6 in the first heat transfer device a) and wraps by the heat transfer media 7aa. Then, the elongated strand shaped material 1 leaves the first heat transfer device a) and enters into the second heat transfer device b). In the second heat transfer device b) the elongated strand shaped material 1 wraps around the two heat transfer media lab and leaves the second heat transfer device b) in the direction of the third heat transfer device c). In the third heat transfer device c) the elongated strand shaped material 1 wraps around the two heat transfer media 7ac and leaves the third heat transfer device c) in the direction of the moving direction 6. Theses heat transfer devices a) to c) each have a housing 20a, 20b, 20c. By these housings 20a to 20c, it is possible that the space surrounding the heat transfer media is filled with a further heat transfer medium 13a, 13b, 13c. In each of the heat transfer devices a) to c), a certain amount of heat from a (not shown) first section 1a of the strand shaped material is transferred to a (not shown) second section 1b of the strand shaped material. By the previously described filling with the heat transfer media 13a to 13c, on the one hand, a better heat transfer between these sections 1a, 1b of the strand shaped material is possible, on the other hand, this leads to the possibility of establishing a protective gas atmosphere for the elongated strand shaped material, and thus to the possibility of reducing a contamination of the strand shaped material.

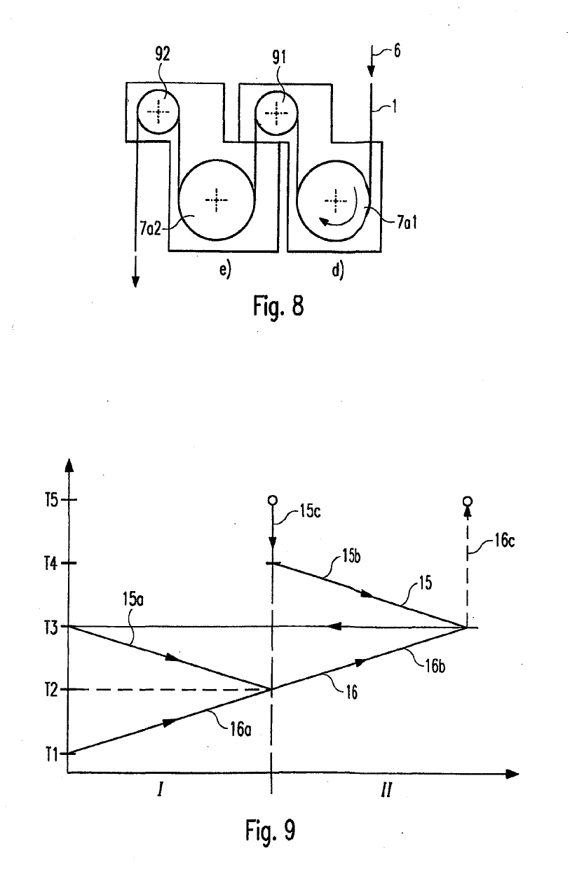

FIG. 8 shows a further cascade-like arrangement of the heat transfer devices according to one embodiment. For this, FIG. 8 shows again only a part of the respective heat transfer devices. Here, these two heat transfer devices d), e) are essentially identical configured. The two heat transfer devices each have the heat transfer media 7a1 and 7a2, respectively and the deflection devices 91 and 92, respectively. The elongated strand shaped material 1 passes through the two heat transfer devices d), e) in the moving direction 6 consecutively. By the configuration of the heat transfer devices in this manner as illustrated in the embodiment, a connection in series of several heat transfer devices is particularly simply, and therefore it is possible to achieve a particularly good heat transfer from the (not shown) first section 1a of the strand shaped material to the (not shown) second section 1b of the strand shaped material.

FIGS. 6 to 8, in each case, only the forward direction or the backward direction of the elongated strand shaped material is shown, so only the first second section 1a of the strand shaped material or the second section 1b of the strand shaped material. The heat transfer media are offset in the direction of the sheet plane and they are each wrapped around by the other section of the strand shaped material 1b or 1a, respectively. For a better understanding, it is referred to the FIGS. 2a and 2b.

FIG. 9 shows a first temperature path 15 for the first section of the strand shaped material and a second temperature path 16 for the second section of the strand shaped material when passing through a two-stage heat transfer device according to one embodiment. Here, the second section of the strand shaped material enters the heat transfer device at the temperature level T1 (second initial temperature), and it receives an amount of heat from the heat transfer medium until it reaches the temperature level T2. The first section of the strand shaped material supplies an amount of heat to the same heat transfer medium, starting from the temperature level T3. The amount of heat results, on the one hand, into a cooling of the first section of the strand shaped materials and the course of the temperature path 15a, and on the other hand it results into a heating of the second section of the strand shaped materials and the course of the temperature path 16a.

After the heat transfer, the second section of the strand shaped material has reached the temperature level T2. The second section of the strand shaped material then receives a further amount of heat from a further heat transfer medium, and it reaches the temperature level T3. The first section of the strand shaped material supplies essentially the additional amount of heat to the same heat transfer medium and it is cooled by the heat transfer from the temperature level T4 (first initial temperature) to the temperature level T3. The heating of the second section of the strand shaped materials results into the course of the temperature path 16b and the cooling of the first section of the strand shaped material results into the course of the temperature path 15b.

The temperature level T5 shows the target temperature for the required annealing process. The temperature difference 15c shows the potential for a third heat transfer stage. The temperature difference 16c shows how much temperature still has to be supplied to the second section of the strand shaped material in order to reach the target temperature. This can be supplied for example by an additional temperature control device (FIG. 6).

While the inventive technology has been described with reference to the figures, it will be understood by those of ordinary skill in the art that various changes in form and details may be made therein without departing from the spirit and scope as defined by the following claims.

What is claimed is:

1. An apparatus for a processing a strand shaped material including a heat transfer device,
wherein the apparatus is adapted to process an elongated strand shaped material and, wherein the heat transfer device comprises a heat transfer medium and is configured to process a first section of the strand shaped material having a first initial temperature, and wherein the heat transfer device is configured to reduce the first initial temperature based on conduction of a heat flow,
wherein the heat transfer device is further configured to process a second section of the strand shaped material having a second initial temperature lower than the first initial temperature, and
wherein the heat transfer medium is configured to conduct the energy flow to the second wire section so as to increase the second initial temperature.

2. The apparatus according to claim 1, wherein the heat transfer medium is in liquid form or in a gaseous form.

3. The apparatus according to claim 1, wherein the heat transfer medium is configured to be in direct contact, at least temporarily, with the first section of the strand shaped material and wherein the heat transfer medium is configured to be in direct contact, at least temporarily, with the second section of the strand shaped material.

4. The apparatus according to claim 1, wherein the heat transfer medium is configured to be guided in a heat medium guiding device and wherein the heat transfer medium is not in direct contact with the first section of the strand shaped material and with the second section of the strand shaped material.

5. The apparatus according to claim 1, wherein the heat transfer medium includes a solid having a specific geometric structure and wherein the heat transfer medium is in direct contact with the first section of the strand shaped material and additionally or alternatively with the second section of the strand shaped material.

6. The apparatus according to claim 5, wherein the heat transfer medium has a substantially rotationally symmetrical configuration and wherein the configuration comprises a circular cross-sectional area and a longitudinal extension, which is arranged substantially perpendicular to the cross-sectional area, and a lateral area, which is substantially cylindrical and which surrounds the cross-sectional area.

7. The apparatus according to claim 6, wherein the substantially rotationally symmetrical configuration comprises a roller-like configuration,

8. The apparatus according to claim 6, wherein the substantially cylindrical lateral area has a groove-like indentation, and wherein the groove-like indentation is configured to guide the first section of the strand shaped material or the second section of the strand shaped material at least in sections.

9. The apparatus according to claim 8, wherein the heat transfer medium has a first groove-like indentation configured to guide the first section of the strand shaped material and a second groove-like indentation configured to guide the second section of the strand shaped material.

10. The apparatus according to claim 5, wherein the first section of the strand shaped material wraps around the heat transfer medium with a first wire wrapping angle α, and wherein the second section of the strand shaped material wraps around the heat transfer medium with a second wire wrapping angle 13.

11. The apparatus according to claim 10, wherein the first wire wrapping angle and the second wire wrapping angle are different.

12. The apparatus according to claim 11, wherein the first wire wrapping angle is smaller than the second wire wrapping angle.

13. The apparatus according to claim 5, wherein a first amount of heat Q1 is configured to be transferred from the first section of the strand shaped material to the heat transfer medium,
wherein a second amount of heat QII is configured to be transferred from the heat transfer medium to the second section of the strand shaped material,
wherein QI substantially corresponds to QII,
wherein the amount of heat QI is affected by the wire wrapping angle α and that the amount of heat QII is affected by the wire wrapping angle β,
wherein during the transfer of the amount of heat QI a constant K is set and that during the transfer of heat QII a constant L is set and
wherein α*K=β*L.

14. The apparatus according to claim 5, wherein the heat transfer device comprises at least one of the heat transfer media, and
wherein the axis of rotation of the heat transfer medium is aligned substantially orthogonal to a moving direction of the first section of the strand shaped material or of the second section of the strand shaped material,
wherein the apparatus further comprises a deflection device, wherein the deflecting device is constructed substantially as a roller means, wherein a rotation axis of the deflection device is arranged askew in regard to the rotation axis of the heat transfer device and wherein one of the first section of the strand shaped material or the second section of the strand shaped material alternately contacts the heat transfer device and the deflection device.

15. The apparatus according to claim 5, wherein the rotation axis of the heat transfer device is arranged skewed in regard to the moving direction of the first section of the strand shaped material or of the second section of the strand shaped material.

16. The apparatus according to claim 1, wherein the heat transfer device includes a plurality of heat transfer devices arranged one behind the other in the movement direction of the elongated strand shaped material, so that the elongate strand shaped material passes in succession through the multiple heat transfer devices during the processing.

17. A method of operating an apparatus for a processing a strand shaped material, the method comprising:
discharging an energy flow of a first section of the strand shaped material;
conducting at least a part of the energy flow to a heat transfer medium;
transmitting at least a part of the energy flow by the heat transfer medium to a second section of the strand shaped material; and
supplying at least a part of the energy flow to the second section of the strand shaped material.

18. The method according to claim 17, wherein the energy flow comprises a heat flow.
